(19) United States
(12) Patent Application Publication
(10) Pub. No.: US 2016/0042676 A1
(43) Pub. Date: Feb. 11, 2016

(54) APPARATUS AND METHOD OF DIRECT MONITORING THE AGING OF AN OLED DISPLAY AND ITS COMPENSATION

(71) Applicant: SAMSUNG DISPLAY CO., LTD., Yongin-City (KR)

(72) Inventors: Brian H. Berkeley, Saratoga, CA (US); David M. Hoffman, Fremont, CA (US); Jiuzhi Xue, Broomfield, CO (US)

(21) Appl. No.: 14/810,403

(22) Filed: Jul. 27, 2015

Related U.S. Application Data
(60) Provisional application No. 62/034,096, filed on Aug. 6, 2014.

(51) Int. Cl. G09G 3/00; G09G 3/32; F21V 8/00

(52) U.S. Cl. CPC G09G 3/006; G02B 6/0006; G09G 3/3208; B82Y 20/00

(57) ABSTRACT

A display including a light emitting display panel; an optical layer on the display panel including: a waveguide; and a light coupling component in the waveguide; a detector optically coupled to the waveguide; and an on-board calibration unit electrically coupled to the detector and configured to modify the output of the light emitting display panel based on a measurement made by the detector.

### CROSS-REFERENCE TO RELATED APPLICATION(S)

This application claims priority to and the benefit of U.S. Provisional Application No. 62/034,096, filed on Aug. 6, 2014 in the U.S. Patent and Trademark Office, the entire content of which is incorporated herein by reference.

### BACKGROUND

1. Field

One or more example embodiments of the present invention relate to an organic light-emitting display apparatus and a method of driving the same.

2. Description of the Related Art

Organic light emitting diode (OLED) displays are emissive displays. They differ from several other types of displays in that each pixel makes its' own light. There are various examples of emissive displays such as OLED displays, plasma displays, etc.

Because the OLED produces its own light, each area of the screen that is illuminated, or is illuminating, has an age and use related degradation, causing a reduced pixel luminance. In normal use, certain areas of the screen are lit up more than other areas. For example, the subset of heavily used pixels may dim more with age than less-used pixels. When the imagery changes, some of the differences may become apparent.

When a screen deteriorates about the same amount at every pixel point it is not very noticeable, but when there's differential aging (i.e., a screen deteriorates in some spots more than others) of as little as one to five percent, a typical observer or consumer may notice. Differential aging is commonly referred to as burn-in.

### SUMMARY

One or more example embodiments of the present invention include an organic light-emitting display apparatus capable of accurately detecting degradation of pixel light output of organic light emitting diodes (OLEDs) and providing a compensation factor to correct pixel luminance, and a method of detecting the degradation of pixel light output of organic light emitting diodes (OLEDs) and providing a compensation factor to correct pixel luminance in the organic light-emitting display apparatus.

Additional aspects will be set forth in part in the description which follows and, in part, will be apparent from the description, or may be learned by practice of the presented embodiments.

A display according to an embodiment of the present invention includes a light emitting display panel; an optical layer on the display panel including: a waveguide; and a light coupling component in the waveguide; a detector optically coupled to the waveguide; and an on-board calibration unit electrically coupled to the detector and configured to modify the output of the light emitting display panel based on a measurement made by the detector.

The light coupling component may include a plurality of anisotropic scatterers. The anisotropic scatterers may be substantially distributed near the interface of the core and cladding of the waveguides and the anisotropic scatterers may be arranged in N rows and M columns, where N and M are natural numbers.

The light coupling component may include a plurality of quantum dots.

The display panel may include a plurality of pixels, the waveguide may include a plurality of waveguides, and the pixels may be arranged in N rows and M columns, where N and M are natural numbers.

The plurality of waveguides may include N waveguides, and each of the waveguides may correspond to one of the rows of the pixels.

Each of the pixels may include multiple (S) sub-pixels, the plurality of waveguides may include M*S waveguides, and each of the waveguides may correspond to one of the columns of sub-pixels.

The plurality of waveguides may include M/i waveguides (i is a natural number), and each of the waveguides may correspond to i of the columns of the pixels.

The waveguide may include a plurality of fibers.

The detector may include a plurality of detectors, each of the detectors may be coupled to a corresponding one of the waveguides, and the detectors may be located at alternating sides of the display panel.

A display panel according to an embodiment of the present invention includes an optical layer on the display panel; a detector configured to detect light transmitted by the optical layer; and an on-board calibration unit electrically coupled to the detector and configured to modify the output of the light emitting display panel based on a measurement made by the detector.

The optical layer may include a plurality of anisotropic scatterers.

The optical layer may include a plurality of quantum dots.

The display panel may further include a plurality of pixels, the optical layer may include a plurality of waveguides, the detector may include a plurality of detectors, and the pixels may be arranged in N row and M columns, where N and M are natural numbers.

The plurality of waveguides may include N waveguides, and each row of pixels may correspond to one of the waveguides and two of the detectors.

Each of the pixels may include multiple (S) sub-pixels, the plurality of waveguides may include M*S waveguides, and each of the waveguides may correspond to one column of sub-pixels and two of the detectors.

The detector may include a plurality of detectors, the optical layer may include a plurality of waveguides, each of the detectors may be coupled to a corresponding one of the waveguides, and the detectors may be located at alternating sides of the display panel.

A method of compensating for degradation of a display panel according to an embodiment of the present invention includes measuring a sample intensity value for each of a plurality of pixels; comparing the sample intensity value of each of the pixels to a corresponding reference pixel intensity value, to compute a difference value for each of the pixels; calculating a compensation factor for each of the pixels based on the corresponding difference value; and storing the compensation factor for each of the pixels.

The method may further include adjusting pixel luminance based on the compensation factor.

The method may further include storing background intensity values for each of a plurality of detectors; and subtracting the background intensity values from the sample intensity values for each of the pixels, respectively.

The sample intensity values may be measured in a number of discrete measurements.

### BRIEF DESCRIPTION OF THE DRAWINGS

FIG. 1 is a block diagram of an organic light emitting diode (OLED) display according to an embodiment of the present invention.

FIG. 2 is an exploded perspective view of an OLED display according to an embodiment of the present invention.

FIG. 3 is a perspective view of an optical layer according to an embodiment of the present invention.

FIG. 4 is a perspective view of an optical layer according to another embodiment of the present invention.

FIG. 5 is a plan view of an optical layer according to an embodiment of the present invention.

FIG. 6 is a plan view of an optical layer according to another embodiment of the present invention.

FIG. 7 is a conceptual diagram of the placement and size of the waveguides relative to the pixels according to an embodiment of the present invention.

FIG. 8 is a conceptual diagram of the placement and size of the waveguides relative to the pixels according to another embodiment of the present invention.

FIG. 9 is a conceptual diagram of the placement and size of the waveguides relative to the pixels according to another embodiment of the present invention.

FIG. 10 is a conceptual diagram of the placement and size of the waveguides relative to the pixels according to another embodiment of the present invention.

FIG. 11 is a diagram showing a scheme for measuring the output of each pixel according to an embodiment of the present invention.

FIG. 12 is a diagram showing a scheme for measuring the output of each pixel according to another embodiment of the present invention.

FIG. 13 is a diagram of light coupling in an embodiment of the present invention when the coupling components include a plurality of anisotropic scatterers.

FIG. 14 is a diagram of light coupling in an embodiment of the present invention when the coupling components include a plurality of quantum dots.

FIG. 15 is a flowchart illustrating a method of determining a reference compensation factor according to an embodiment of the present invention.

FIG. 16 is a flowchart illustrating a method of determining a compensation factor and compensating pixels in an organic light-emitting display according to an embodiment of the present invention.

### DETAILED DESCRIPTION

Reference will now be made in detail to example embodiments of the present invention, examples of which are illustrated in the accompanying drawings, wherein like reference numerals refer to like elements throughout. In this regard, the present example embodiments may have different forms and should not be construed as being limited to the descriptions set forth herein. Accordingly, the example embodiments are merely described below, by referring to the figures, to explain aspects of the present invention.

It will be understood that, although the terms “first”, “second”, “third”, etc., may be used herein to describe various elements, components, regions, layers, and/or sections, these elements, components, regions, layers and/or sections should not be limited by these terms. These terms are only used to distinguish one element, component, region, layer or section from another element, component, region, layer or section. Thus, a first element, component, region, layer, or section discussed below could be termed a second element, component, region, layer, or section, without departing from the spirit and scope of the present invention.

Spatially relative terms, such as “beneath”, “below”, “lower”, “under”, “above”, “upper” and the like, may be used herein for ease of description to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly.

Further, it will also be understood that when one element, component, region, layer and/or section is referred to as being “between” two elements, components, regions, layers, and/or sections, it can be the only element, component, region, layer and/or section between the two elements, components, regions, layers, and/or sections, or one or more intervening elements, components, regions, layers, and/or sections may also be present.

The terminology used herein is for the purpose of describing particular embodiments only and is not intended to be limiting of the present invention. As used herein, the singular forms “a” and “an” are intended to include the plural forms as well, unless the context clearly indicates otherwise. It will be further understood that the terms “include,” “comprises,” “comprising,” “includes,” “including,” and “include,” when used in this specification, specify the presence of stated features, natural numbers, steps, operations, elements, and/or components, but do not preclude the presence or addition of one or more other features, natural numbers, steps, operations, elements, components, and/or groups thereof.

It will be understood that, although the terms “row” or “column” may be used herein to describe various embodiments of the present invention, these embodiments should not be limited by these terms. These terms are only used to distinguish one direction from another and do not denote a specific orientation. Thus, a row discussed below could be termed a column, without departing from the spirit and scope of the present invention.

As used herein, the term “and/or” includes any and all combinations of one or more of the associated listed items. Expressions such as “at least one of,” when preceding a list of elements, modify the entire list of elements and do not modify the individual elements of the list. Further, the use of “may” when describing embodiments of the present invention refers to “one or more embodiments of the present invention.” Also, the term “example” is intended to refer to an example or illustration.

It will be understood that when an element or layer is referred to as being “on,” “connected to,” “coupled to,” “connected with,” “coupled with,” or “adjacent to” another element or layer, it can be “directly on,” “directly connected to,” “directly coupled to,” “directly connected with,” “directly coupled with,” or “directly adjacent to” the other element or layer, or one or more intervening elements or layers may be present. When an element or layer is referred to as being “directly on,” “directly connected to,” “directly coupled to,” “directly connected with,” “directly coupled with,” or “immediately adjacent to” another element or layer, there are no intervening elements or layers present.

As used herein, the term “substantially,” “about,” and similar terms are used as terms of approximation and not as terms of degree, and are intended to account for the inherent deviations in measured or calculated values that would be recognized by those of ordinary skill in the art.

As used herein, the terms “use,” “using,” and “used” may be considered synonymous with the terms “utilize,” “utilizing,” and “utilized,” respectively.

The organic light emitting diode (OLED) display and/or any other relevant devices or components according to embodiments of the present invention described herein, may be implemented utilizing any suitable hardware, firmware (e.g. an application-specific integrated circuit), software, or a suitable combination of software, firmware, and hardware.

Embodiments of the present invention may reduce or eliminate the effects of differential aging (i.e., differential pixel degradation) that generally results in a reduction in pixel luminance.

Pixel degradation rates can be affected by multiple factors. These factors include: material properties, device design (e.g., thickness of injection, interlayer, and transport layers, electrode separation, electrode resistance, current density, aperture ratio, subpixel open area, etc.), operating temperature, average pixel luminance, individual pixel history, red, green, and blue (RGB) differences, etc. Pixel degradation causes a reduction in pixel luminance that can be associated with greater voltage drop, charge traps, lower optical outcoupling efficiency or lower quantum efficiency.

Hereinafter, embodiments of the present invention will be described with reference to the accompanying drawings. While example embodiments of the present invention are described with reference to an organic light emitting diode (OLED) display, one of ordinary skill in the art would recognize that embodiments of the present invention may be applied to any suitable type of display. For example, the present invention may be applied to any suitable display that may have differential aging.

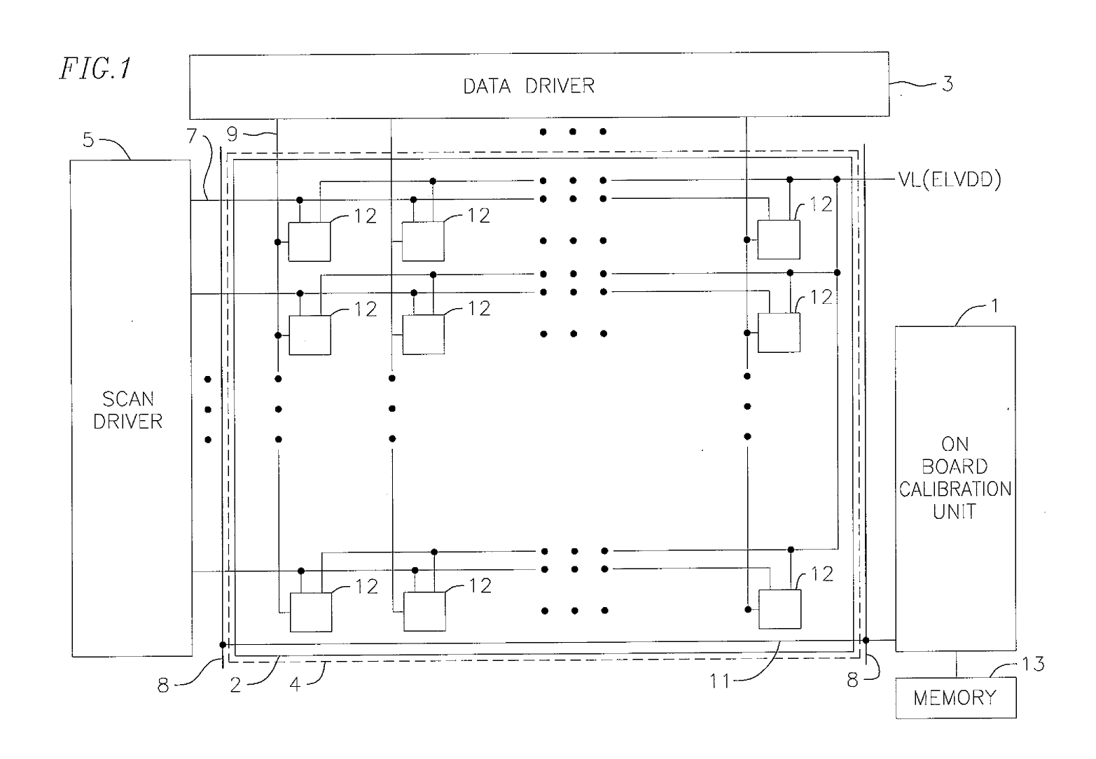

FIG. 1 is a block diagram of an organic light emitting diode (OLED) display according to an embodiment of the present invention.

A person of skill in the art should recognize that the process may be executed via hardware, firmware (e.g. via an ASIC), or in any combination of software, firmware, and/or hardware. Furthermore, the sequence of steps of the process is not fixed, but can be altered into any desired sequence as recognized by a person of skill in the art. The altered sequence may include all of the steps or a portion of the steps.

The on-board calibration unit 1 and/or any other relevant devices or components according to embodiments of the present invention described herein, may be implemented utilizing any suitable hardware, firmware (e.g. an application-specific integrated circuit), software, or a suitable combination of software, firmware, and hardware. For example, the various components of the on-board calibration unit 1 may be formed alongside other functions on one integrated circuit (IC) chip, on a single dedicated IC chip, or on separate IC chips. Further, the various components of the on-board calibration unit 1 may be implemented on a flexible printed circuit film, a tape carrier package (TCP), a printed circuit board (PCB), or formed on a same substrate as the on-board calibration unit 1. Further, the various components of the on-board calibration unit 1 may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the scope of the exemplary embodiments of the present invention.

The on-board calibration unit 1 may be in electronic communication with a processor or controller or may include a processor or controller, which processes data received by the on-board calibration unit 1. The on-board calibration unit 1 may further include several other components that are controlled by the processor or controller. For example, the on-board calibration unit 1 may include a mass storage device or memory, representing one or more memory devices or components electrically connected to the processor for storing data on non-volatile memory for future access by the processor or controller. The memory may include any suitable mass storage device such as flash memory, secure digital (SD) memory, etc. The memory may further include an addressable memory unit for storing software instructions to be executed by the processor or controller. For example, the memory may include any suitable addressable memory device, such as a random access memory (RAM), and may additionally operate as a computer-readable storage medium having non-transitory computer readable instructions stored therein that, when executed by a processor, cause the processor to control components of the on-board calibration unit 1 to provide a compensation mode.

Referring to FIG. 1, a display according to an embodiment may include an on-board calibration unit 1, a display panel 2 for displaying images, a data driver 3, optical layer 4, a scan driver 5, detectors 8, detector line 11, and memory 13. The display panel 2 may include pixels 12 arranged in a matrix form, scan lines 7, and data lines 9.

Each of the plurality of pixels 12 is coupled to respective ones of the scan lines 7 and data lines 9 at crossing portions of the scan lines 7 and the data lines 9. Each of the pixels 12 receives a data signal from the data driver 3 through the respective one of the data lines 9, when a scan signal is received from the scan driver 5 through a respective one of the scan lines 7.

The scan lines 7 may transfer scan signals. The scan lines 7 may extend parallel to each other along a first direction. The data lines 9 may transfer data signals. The data lines 9 may extend parallel to each other along a second direction crossing the first direction. The detector line 11 may transfer signals from the detectors 8 to the on-board calibration unit 1. Memory 13 may store pixel intensity values for use by the on-board calibration unit 1.

The scan lines 7 and the data lines 9, crossing each other, may form a plurality of divided sections in a matrix form. Each of the divided sections outlined (e.g., surrounded) by the scan lines 7 and the data lines 9 crossing each other may be divided into a transistor region and an emission region.

The driving voltage line VL may transfer power voltage ELVDD and may be formed in a mesh pattern or arrangement. A portion of the driving voltage line VL may be parallel to the data lines 9.

The scan driver 5 may be coupled to the display panel 2 via the scan lines 7. Scan signals from the scan driver 5 may be supplied to the pixels 12 via the scan lines 7.

The data driver 3 may be coupled to the display panel 2 via the data lines 9. Data signals may be supplied to the pixels 12 from the data driver 3 via the data lines 9.

Each of the pixels 12 that receive the above-described scan signal and data signal may control ON/OFF of the driving transistor through the switching transistor. The driving transistor may supply driving current to the organic light emitting diode OLED according to the data signals.

The organic light emitting diode OLED that receives the driving current may generate light corresponding to (e.g., according to or based on) the driving current.

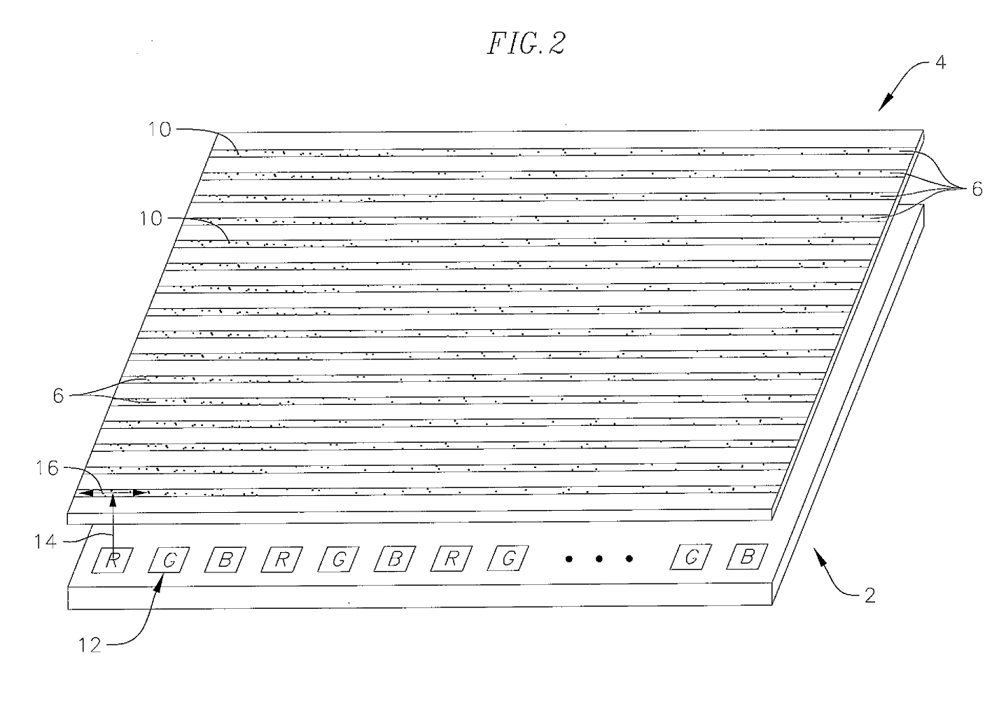

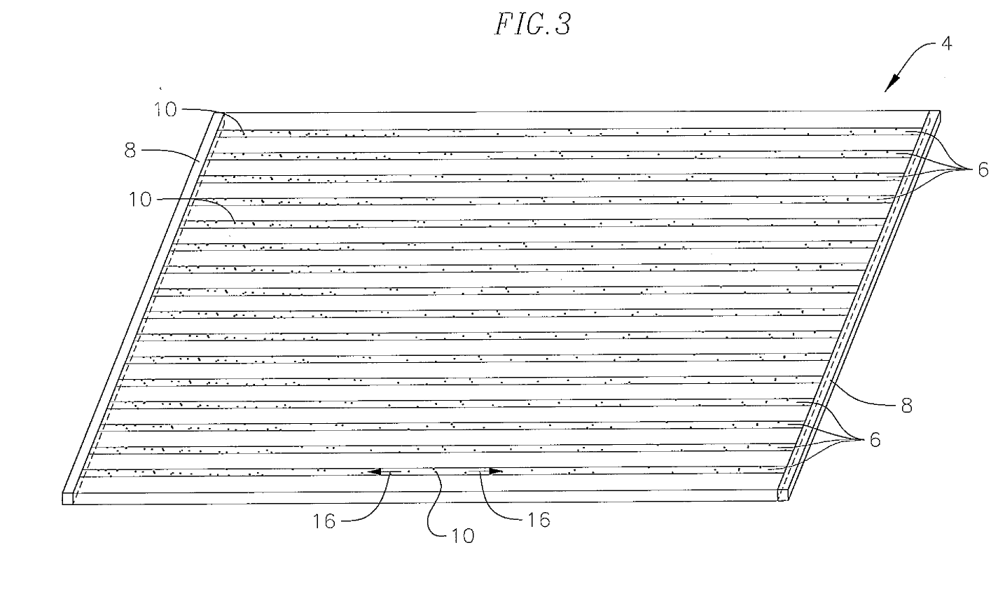

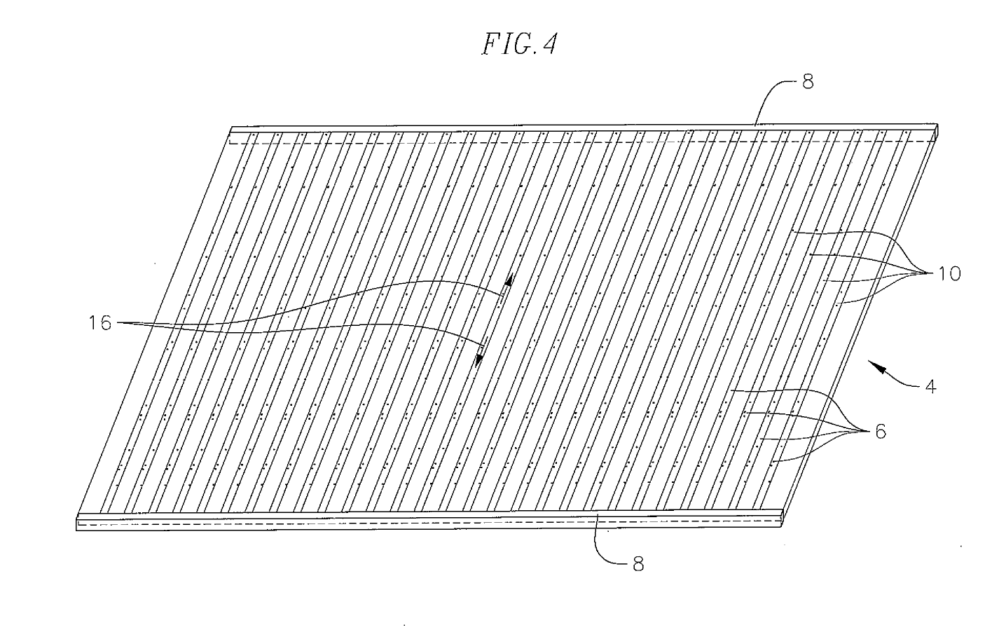

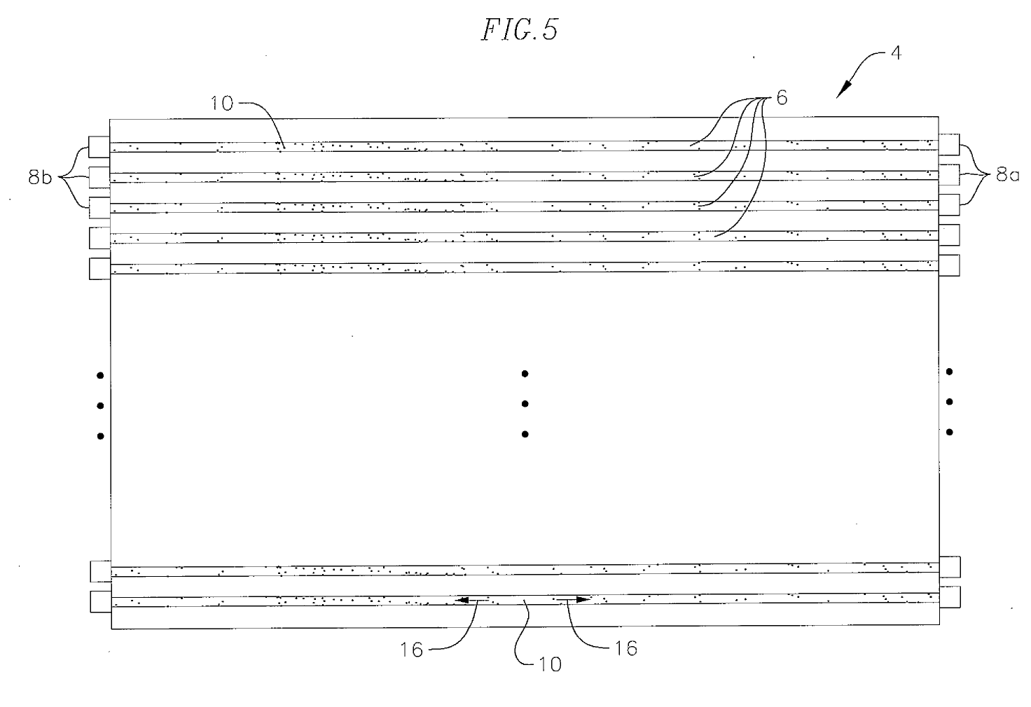

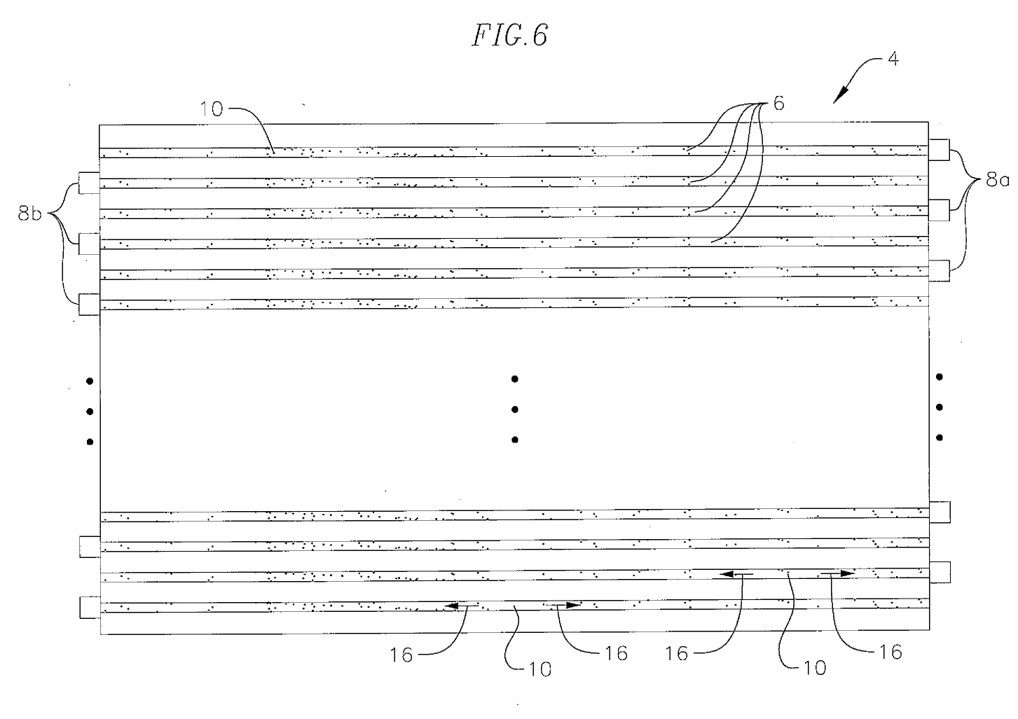

FIG. 2 is an exploded perspective view of an organic light emitting diode (OLED) display according to an embodiment of the present invention. FIG. 3 is a perspective view of an optical layer according to an embodiment of the present invention. FIG. 4 is a perspective view of an optical layer according to another embodiment of the present invention. FIG. 5 is a plan view of an optical layer according to an embodiment of the present invention. FIG. 6 is a plan view of an optical layer according to another embodiment of the present invention. Referring to FIGS. 2 through 6, the OLED display of an example embodiment includes a display panel 2 (e.g., an OLED display panel), an optical layer 4 on the display panel, and an array of detectors 8 at edges of the optical layer.

A display according to an embodiment of the present invention may operate in a compensation mode (e.g., a field calibration mode) for detecting the degradation of the pixels 12 and store a compensation factor for each pixel. The compensation factor may be used during operation of the display in order to compensate for degradation of the pixel luminance and correct pixel luminance.

A display according to an embodiment of the present invention may activate a compensation mode based on an input from a user, a preset time of day, a number of operation hours, an ambient light sensor, switching the display on or off, etc. or the display may activate the compensation mode based on any suitable combination of two or more of these.

When the compensation mode is activated and there is ambient light around the display, ambient light may be coupled into the waveguides 6. When ambient light is coupled into the waveguides 6, an inaccuracy may be introduced in the measurements by the detectors 8. As such, the compensation factor may be incorrect and an additional brightness error may be introduced into the display.

When there is too high of an ambient light level, a compensation mode can be delayed until a time where the ambient light is negligible (e.g., the middle of the night).

Further, when the field calibration mode is activated and there is ambient light, the compensation mode may cause the detectors to measure the ambient light when the pixels are not emitting thereby measuring the effect of the ambient light. The effect of the ambient light may then be removed from the measured value of the coupled light when the pixels are emitting. Therefore, the effects of ambient light can be reduced, subtracted, or eliminated. When the ambient light is too great, the detectors may be overwhelmed by the light and it may be necessary to postpone the compensation mode until a time when the ambient light is reduced.

Referring to FIG. 2, the display panel 2 includes a plurality of pixels 12, which are each configured to emit light 14 of a respective brightness according to data signals received from the data driver 3. The optical layer 4 includes waveguides 6 and coupling components 10 inside the waveguides 6. The waveguides 6 may be any suitable optically clear material that encouples a portion of the light 14 from the pixels 12 and transmits the coupled light 16 to the detectors 8 (e.g., using optically clear fibers). The coupling components are any suitable materials for causing a portion of the light 14 to couple into the waveguides 6 (e.g., anisotropic scatterers, quantum dots, etc.).

As light 14 is emitted from the pixels 12 it passes through the optical layer 4 which is on the display panel 2. The optical layer 4 may be directly on the display panel 2 or one or more layers may be present between the display panel 2 and the optical layer 4.

As the light 14 passes through the optical layer 4 and the waveguides 6, a portion of the light 14 is coupled to the waveguides 6 by the coupling components 10. The coupled light 16 is transmitted down the length of the waveguides 6. In this way, a portion of the light 14 emitted from the pixels 12 is captured and sent in a direction (or directions) parallel to the surface of the display panel 2.

The optical layer 4, including the waveguides 6, may be transparent in order to allow the light from the display panel 2 to pass through. The portion of light coupled by the coupling components 10 may be small (e.g., less than 1%) in order to reduce or minimize the effect of embodiments of the present invention on the overall brightness of the display. The optical layer 4 may be an optical film, for example.

Referring to FIGS. 2, 3, and 4, the OLED display according to an embodiment of the present invention may include detectors 8 adjacent to the optical layer 4. When the coupling components 10 couple the light 14 into the waveguides 6, the coupled light 16 is transmitted to the detectors 8. The detectors 8 are optically coupled to the waveguides 6 in order to receive the coupled light 16.

The amount of light received at the detector for each pixel can be compared to a corresponding reference pixel intensity value, respectively. Based on the comparison between the measured value and the corresponding reference pixel intensity value, a compensation factor can be determined for each pixel. The compensation factors can be stored and used to compensate for degradation of the pixel luminance and correct pixel luminance during operation of the display. In this way, differential aging of the pixels can be compensated for and the effects can be reduced or eliminated.

As shown in FIG. 3, the waveguides 6 may extend in a length direction (or parallel to the longer sides) and the detectors 8 may be located at either end or both ends of the optical layer 4 in the longer direction. Alternately, as shown in FIG. 4 the waveguides 6 may be arranged in a shorter direction and the detectors 8 may be located at either end or both ends of the optical layer 4 in the shorter direction. When the waveguides 6 are arranged in the longer direction, a lower number of waveguides 6 and detectors 8 may be used, but a detection process may take a longer time due to each waveguide 6 covering a higher number of pixels. When the waveguides 6 are arranged in the shorter direction, a higher number of waveguides 6 and detectors 8 may be used, but a detection process may be shorter due to each waveguide 6 covering a lower number of pixels.

Referring to FIG. 5, the display according to an embodiment of the present invention may include first detectors 8a. In the present embodiment, each first detector 8a is coupled to one corresponding waveguide 6. When light 14 is emitted from one of the pixels 12, the coupling components 10 cause a portion of the light 14 to be coupled into waveguides 6. The coupled light 16 is transmitted through the waveguide 6 and the coupled light 16 is transferred to the corresponding first detector 8a, which measures the amount of light received at the first detector 8a. While both detectors 8a and 8b are shown in FIG. 5, in some embodiments, only detectors 8a are present and in other embodiments, only detectors 8b are present.

When a pixel 12 is close to a corresponding first detector 8a, a relatively greater amount of light may be received at the corresponding first detector 8a. When a pixel 12 is far from a corresponding first detector 8a, a relatively lower amount of light may be received at the corresponding first detector 8a. Because of this, detection accuracy may vary based upon how far the pixel 12 is from its corresponding first detector 8a.

A display according to another embodiment includes first detectors 8a and second detectors 8b. In the present embodiment, each waveguide 6 is coupled to one corresponding first detector 8a and to one corresponding second detector 8b. When coupled light 16 is transmitted through a waveguide 6, the coupled light 16 is transferred to both the corresponding first detector 8a and to the corresponding second detector 8b, each of which measures the amount of light received at the first detector 8a and second detector 8b, respectively. The measurement from the corresponding first detector 8a and the corresponding second detector 8b can be combined into a measurement by any suitable combination method (e.g., calculating a sum intensity value, calculating an average intensity value, etc.).

The combined amount of light received at the. detector (or detectors) for each pixel can be compared to a corresponding reference pixel intensity value measured, for example, when the display apparatus is manufactured at the factory. Based on the comparison between the combined measured value and the corresponding reference pixel intensity value, a compensation factor can be determined for each pixel. The compensation factors can be stored and used to compensate for degradation of the luminance during operation of the display. In this way, differential aging of the pixels can be more accurately compensated and the effects can be reduced or eliminated.

Referring to FIG. 6, the display according to an embodiment of the present invention may include first detectors 8a and second detectors 8b. In the present embodiment, each first detector 8a and second detector 8b is coupled to one corresponding waveguide 6. When light 14 is emitted from one of the pixels 12, the coupling components 10 cause a portion of the light 14 to be coupled into waveguides 6. The coupled light 16 is transmitted through a waveguide 6 and is transferred to either a corresponding first detector 8a or a corresponding second detector 8b or both, which measures the amount of light received at the first detector 8a or second detectors 8b.

When the size of the waveguides 6 is small, it may be difficult to place a detector at the end of each waveguide 6 at the same side of the optical layer 4. As such, in the present embodiment, odd waveguides 6 are coupled to a corresponding one of the first detectors 8a and even waveguides 6 are coupled to a corresponding one of the second detectors 8b. Because each side of the optical layer 4 only has a first detector 8a or a second detector 8b on every other waveguide 6, the detectors can fit more easily. While the present embodiment shows first detectors 8a connected to odd waveguides 6 and second detectors 8b connected to even waveguides 6, the present invention is not limited thereto and other suitable arrangements may be used.

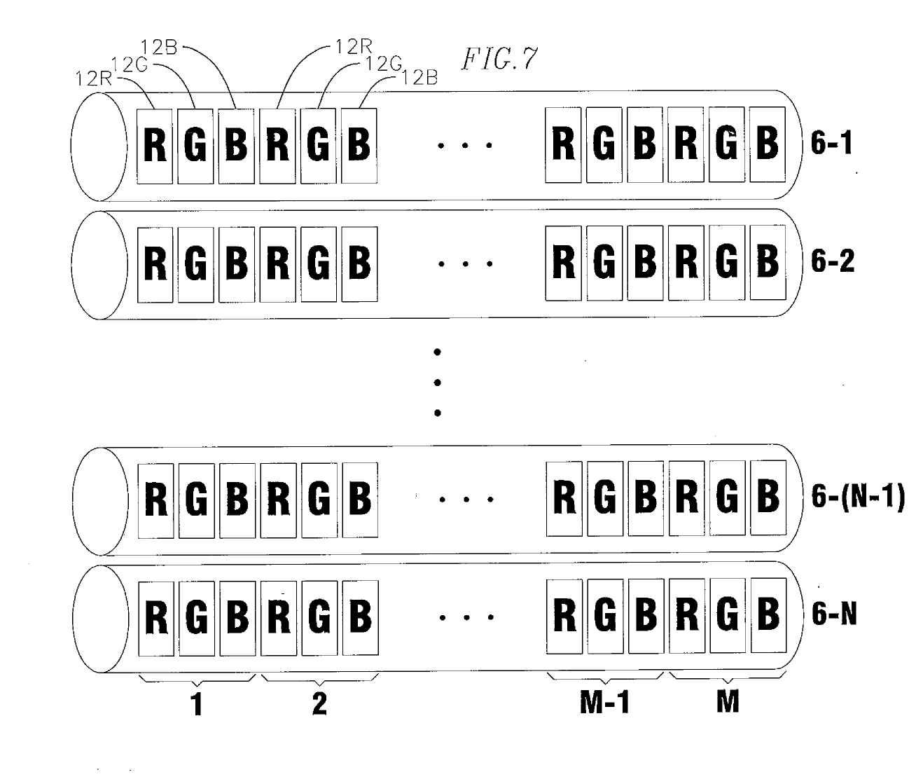

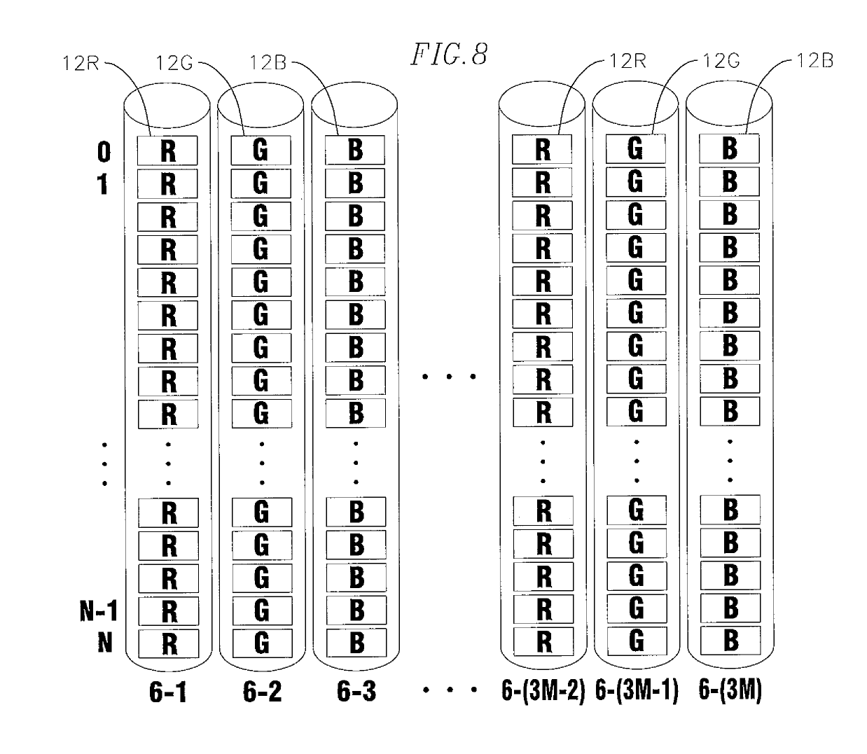

Referring to FIGS. 7 through 9, FIG. 7 is a conceptual diagram of the placement and size of the waveguides relative to the pixels according to an embodiment of the present invention, FIG. 8 is a conceptual diagram of the placement and size of the waveguides relative to the pixels according to another embodiment of the present invention, and FIG. 9 is a conceptual diagram of the placement and size of the waveguides relative to the pixels according to yet another embodiment of the present invention.

Referring to FIG. 7 through 9, an OLED display according to embodiments of the present invention may include a display panel that includes a plurality of pixels 12. The pixels may be arranged in N rows and M columns, where N and M are natural numbers.

In the embodiment of FIG. 7, there are N waveguides 6-1 through 6-N, each waveguide 6 corresponding to one row of pixels 12. In the embodiment where only one sub-pixel (e.g., sub-pixel emitting one of red (R), green (G), and blue (B) light) per waveguide 6 is illuminated at a time, the detectors may each make 3M measurements in order to measure every pixel in the panel (not including any measurements for ambient light adjustment).

In the embodiment of FIG. 8, there are 3M waveguides 6-1 through 6-(3M), each waveguide 6 corresponding to one column of sub-pixels 12R, 12G, or 12B. In the embodiment where only one sub-pixel per waveguide 6 is illuminated at a time, the detectors each make N measurements in order to measure every pixel in the panel (not including any measurements for ambient light adjustment).

In the embodiment of FIG. 9, there are M/2 waveguides 6-1 through 6-(M/2), each waveguide 6 corresponding to six columns of sub-pixels 12R, 12G, and 12B or two columns of pixels (three sub-pixels in each pixel). In the embodiment where only one sub-pixel per waveguide 6 is illuminated at a time, the detectors may each make 6N measurements in order to measure every pixel in the panel (not including any measurements for ambient light adjustment).

While the embodiment of FIG. 9 shows M/2 waveguides 6-1 through 6-(M/2), the present invention is not limited thereto. For example, there may be M/i waveguides 6-1 through 6-(M/i) (i is a natural number), each waveguide 6 corresponding to 3i columns of sub-pixels 12R, 12G, and 12B or i columns of pixels (three sub-pixels in each pixel). In the embodiment where only one sub-pixel per waveguide 6 is illuminated at a time, the detectors may each make 3*i*N measurements in order to measure every pixel in the panel (not including any measurements for ambient light adjustment).

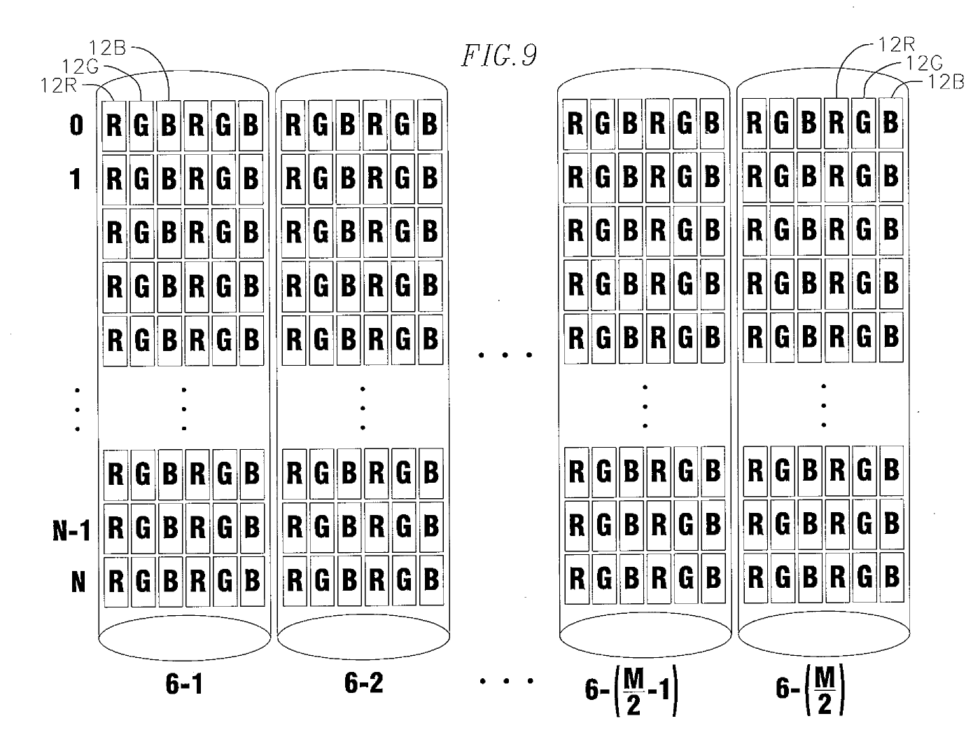

In the embodiment of FIG. 10, there are N/3 waveguides 6-1 through 6-(N/3), each waveguide 6 corresponding to three rows of pixels. In the embodiment where only one sub-pixel per waveguide 6 is illuminated at a time, the detectors may each make 3M measurements in order to measure every pixel in the panel (not including any measurements for ambient light adjustment).

While the embodiment of FIG. 10 shows N/3 waveguides 6-1 through 6-(N/3), the present invention is not limited thereto. For example, there may be N/i waveguides 6-1 through 6-(N/i) (i is a natural number), each waveguide 6 corresponding to i rows of pixels. In the embodiment where only one sub-pixel per waveguide 6 is illuminated at a time, the detectors may each make 3*i*M measurements in order to measure every pixel in the panel (not including any measurements for ambient light adjustment).

While the embodiments of FIGS. 7 through 10 show the waveguides 6 directly over the pixels 12, the present invention is not limited thereto. For example, the waveguides may overlap a portion of one pixel 12 and a portion of an adjacent pixel 12. In this case the measurement from the detectors 8 corresponding to both of the waveguides that overlap one pixel may be used to measure the degradation of the pixel luminance, although this may result in a higher number of measurement per calibration.

While the embodiments of FIGS. 7 through 10 show an integer relationship between the waveguides 6 and the number of rows or columns, the present invention is not limited thereto. For example, the waveguides 6 and the number of rows or columns may have a non-integer relationship such as 1 and a half waveguides per row or column, 3.5 waveguides per row or column, 4.43 rows or columns per waveguide, etc. The waveguides may further be a sheet of high density fibers with the properties described above and that do not require perfect alignment. In this case the measurement from the detectors 8 corresponding to any number of the waveguides that overlap one pixel may be used to measure the degradation of the pixel luminance. This may result in a higher or lower number of measurement per calibration.

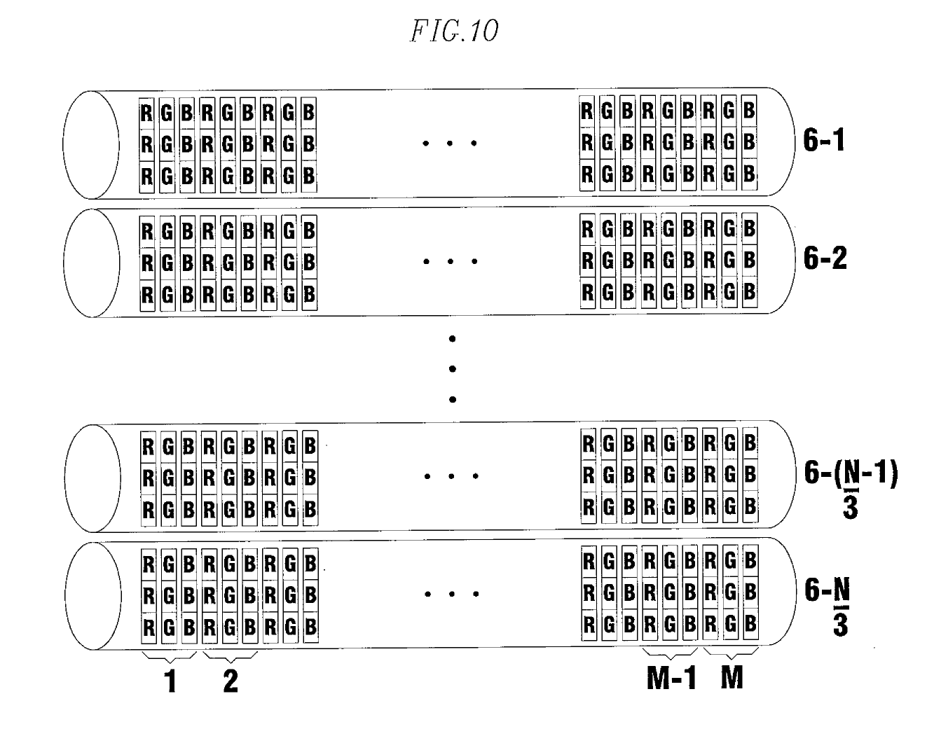

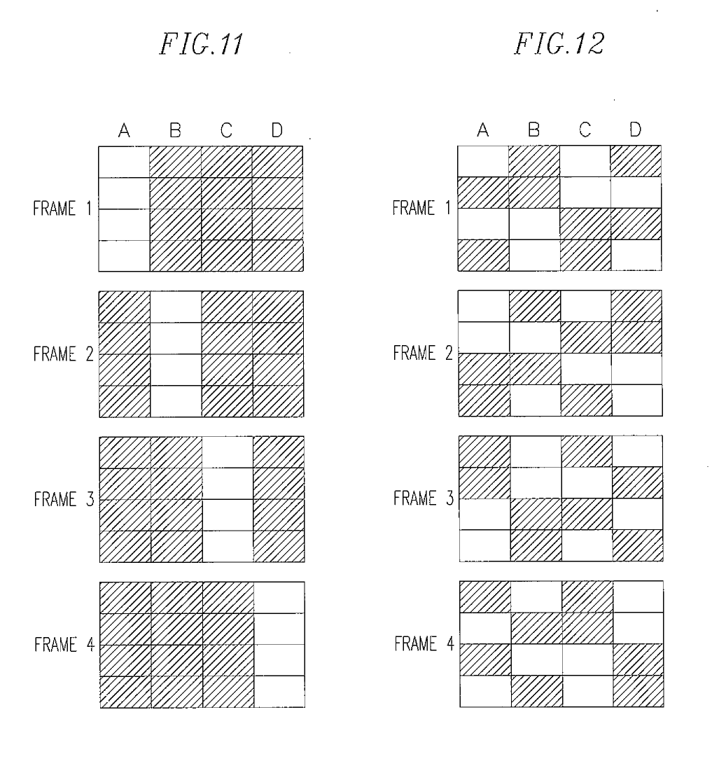

Referring to FIGS. 11 and 12, FIG. 11 is diagram showing a scheme for measuring the output of each pixel according to an embodiment of the present invention and FIG. 12 is diagram showing a scheme for measuring the output of each pixel according to another embodiment of the present invention. In FIGS. 11 and 12, an empty box represents a pixel that is illuminating and a box with a cross-hatch represents a pixel that is not illuminating.

FIG. 11 shows a scheme for illuminating pixels 12 during a compensation mode where there is one waveguide 6 for each row of pixels 12 (as in FIG. 7). During frame 1, the first column of pixels 12 is illuminated and emits light 14. A portion of the light 14 from the first column of pixels 12 is encoupled to the waveguides 6 by the coupling components 10. The waveguides 6 transmit the coupled light 16 to the detectors 8. The detectors 8, at the ends of the waveguides, measure the light coupled from its respective illuminated first column pixel. During frame 2, the second column of pixels 12 is illuminated and emits light 14. In a similar manner as above, a portion of light 14 is encoupled to the waveguides 6 and the encoupled light is transmitted to the detectors 8. The detectors 8 at the end of the waveguides 6 measure the encoupled light 16 from its respective illuminated second columns pixel. The scheme carries on for frame 3, frame 4, and so on for all columns up to and including frame 3M.

Although FIG. 11 represents one possible scheme for illuminating pixels during a compensation mode, the present invention is not limited thereto and one of ordinary skill in the art would recognize that the principles of this scheme can be applied to other situations (e.g., one waveguide per row of pixels, one waveguide per five rows of pixels, etc.). Although a display with four rows, four columns, and four frames has been shown, the present invention is not limited thereto and may have any number of rows, columns, and frames.

It may not be aesthetically pleasing to a viewer to see a display panel illuminate all the pixels column by column. Further, there may be concerns with computation and calibration time requirements. As such, other schemes for illuminating pixels 12 during a compensation mode may be used. FIG. 12 shows an orthogonal scheme for illuminating pixels 12 during a compensation mode where there is one waveguide 6 for each column of pixels 12.

During frame 1, a pattern of pixels 12 is illuminated and emit light 14. A portion of the light 14 from the first pattern of pixels 12 is encoupled to the waveguides 6 by the coupling components 10. The waveguides 6 transmit the coupled light 16 to the detectors 8. The detectors at the end of the waveguides measure the light coupled from its respective illuminated pixels.

During frame 2, the second offset of pixels is illuminated and emits light 14. In a similar manner as above, a portion of light 14 is encoupled to the waveguides 6 and the encoupled light is transmitted to the detectors 8. The detectors at the end of the waveguides measure the light coupled from its respective illuminated pixels. The scheme carries on with frame 3 and frame 4 and their respective pattern forming a complete orthogonal set. When all of the measurements have been made, the on-board calibration unit 1 uses a formula corresponding to the orthogonal patterns to determine the intensity of each pixel 12.

Although FIG. 12 represents one possible orthogonal scheme for illuminating pixels 12 during a compensation mode, the present invention is not limited thereto and one of ordinary skill in the art would recognize that the principles of this scheme can be applied to other situations (e.g., one waveguide per row of pixels, one waveguide per five rows of pixels, etc.).

One of ordinary skill in the art will recognize that while the scheme described with reference to FIG. 11 may be less aesthetically pleasing than the scheme of FIG. 12, it will be less computationally complex than the scheme of FIG. 12, and that while the scheme described with reference to FIG. 12 may be more aesthetically pleasing than the scheme of FIG. 11, it will be more computationally complex than the scheme of FIG. 11.

Both FIGS. 11 and 12 represent preprogrammed patterns of pixels 12 that can be illuminated in sequence. The compensation mode may cause each pixel 12 to be illuminated one or more times.

FIG. 13 is a diagram of light coupling in an embodiment of the present invention when the coupling components include a plurality of anisotropic scatterers. When an object or a particle has an index of refraction different from the material surrounding the object or particle, the object or particle will cause light that is passing through to scatter. When light 14, emitted from a pixel 12, passes through an anisotropic scatterer 18 (e.g., a small particle that has a different index of refraction from the material surrounding the particle and causes light emitted from the pixels 12 to be scattered and encoupled into waveguides 6 while not scattering light that is already encoupled into the waveguide 6), then a portion of the light 14 will be coupled to the waveguide 6.

Light scattering at the pixel level has the added advantage that it may make the light emitted from a pixel closer to a perfect Lambertian source, and a better viewing experience from broader range of directions. There are applications, however, where narrower viewing is preferred to reduce power consumption. In this case, it may be desirable for a limited number of light scatterers to be introduced.

Anisotropic scatterers may have the feature that the polarization of the scattered light is strongly influenced by the orientation of the anisotropic scatterers and the intensity of the scattered light is determined by the relative direction of the polarization of the incident light and the orientation of the scatterers, particularly when the ordinary index of refraction of the scatterers is matched to its surroundings. The light 14 that is emitted from the pixel has an emitted light polarization 22. When the light is scattered by the anisotropic scatterers, scattered light that matches the waveguiding condition will have a polarization direction roughly along the direction of the coupled light polarization 24. The guided wave therefore “sees” ordinary index of refraction of the anisotropic scatters, and in embodiments of the present invention, the anisotropic scatterers may scatter light 14 with a polarization of light emitted from the display but not scatter light 16 with the polarization of the scattered light. In this embodiment, scattered light that is not confined and guided in the waveguides transmit through without change in frequency and the luminance of the pixel is minimally impacted.

Because the scatterers 18 are anisotropic, the coupled light 16 does not scatter when it passes other scatterers, and as such, the coupled light experiences little loss (e.g., a majority of the light that is encoupled into the waveguides 6 is received at the detectors 8). Although the present embodiment utilizes anisotropic scatterers, the present invention is not limited thereto and any suitable scatterer may be used.

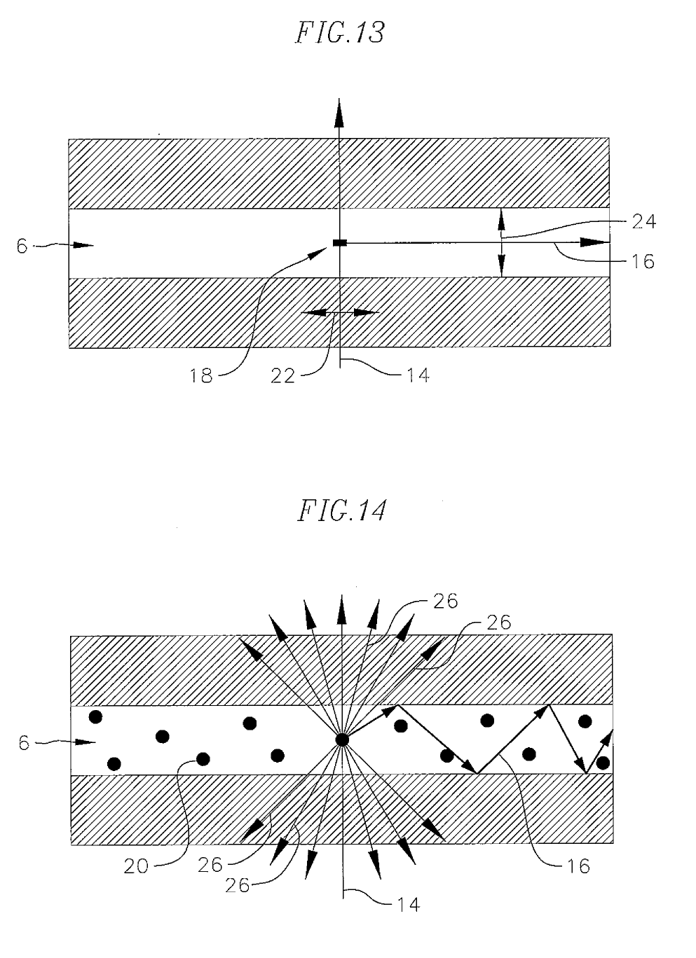

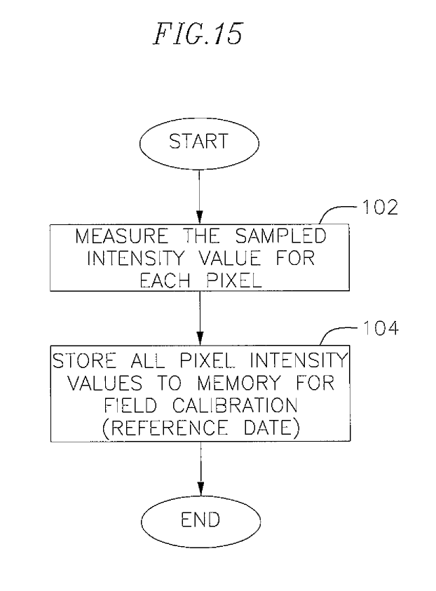

FIG. 14 is a diagram of light coupling in an embodiment of the present invention when the coupling components include a plurality of quantum dots.

A controlled amount of light 14 may be coupled into the waveguides 6 by using suitable types of nanoparticles, such as quantum dots 20. A quantum dot 20 operates to frequency shift light by absorbing a photon in the visible spectrum and emitting photons in an invisible spectrum (e.g., the infrared spectrum). In this case, when a photon hits the quantum dot 20, the photon is shifted to infrared (IR) light or to an IR wavelength (i.e., absorbed and IR photons are emitted), and it scatters in all directions, so the photons can go in any direction. Some of the photons may leave the display or bounce back in.

Most of the photons may be coupled to the waveguides 6, and at that point those IR photons are able to pass through the other quantum dots in the waveguide because the quantum dots 20 only absorb light within the visible spectrum. Therefore, according to embodiments of the present invention, it may be possible to tune the density of the nanoparticles that are in the waveguide to achieve a desired sampling fraction (e.g., 1%, 10%, etc.).

Further by converting the visible light into infrared light, if any of the coupled light 16 leaks out of the waveguide at a location other than where the light 14 is emitted from the pixels, it may not cause visibility problems on the screen. Further, when using quantum dots 20, the entire waveguide 6 is conductive to the infrared light and as such a decrease over distance can be reduced or substantially prevented.

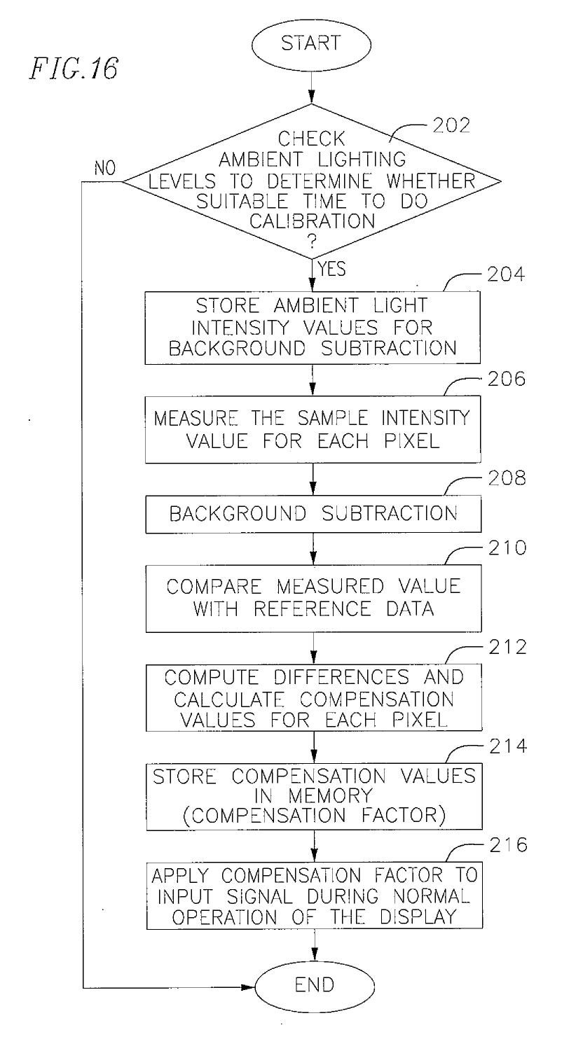

FIG. 15 is a flowchart illustrating a method of determining a reference compensation factor according to an embodiment of the present invention. A person of skill in the art should recognize that the process may be executed via hardware, firmware (e.g. via an ASIC), or in any combination of software, firmware, and/or hardware. Furthermore, the sequence of steps of the process is not fixed, but can be altered into any desired sequence as recognized by a person of skill in the art. The altered sequence may include all of the steps or a portion of the steps.

Before the display leaves the factory (e.g., during production), the on-board calibration unit 1 performs a factory calibration. During the factory calibration, at block 102, the on-board calibration unit 1 samples an intensity value for each of the pixels. Each pixel is provided with a same or a preset data signal. The data signals are not all provided at once, but rather, the data signals can be applied as discussed with reference to FIGS. 11 and 12. The coupling components 10 cause a portion of the light 14 emitted by the pixels 12 to be coupled to the waveguides 6. The waveguides transmit the coupled light 16 to the detectors 8 which measure the intensity of light. The detectors 8 provide the sample intensity values to the on-board calibration unit 1.

At block 104, the on-board calibration unit 1 stores the intensity values in memory 13 as reference pixel intensity values for use during field calibrations. In an embodiment of the present invention, the factory calibration is performed in a dark room to reduce or eliminate errors caused by ambient light.

FIG. 16 is a flowchart illustrating a method of determining a compensation factor and compensating pixels in an organic light-emitting display according to an embodiment of the present invention. A person of skill in the art should recognize that the process may be executed via hardware, firmware (e.g. via an ASIC), or in any combination of software, firmware, and/or hardware. Furthermore, the sequence of steps of the process is not fixed, but can be altered into any desired sequence as recognized by a person of skill in the art. The altered sequence may include all of the steps or a portion of the steps.

A display according to an embodiment of the present invention may activate a field calibration based on an input from a user, a preset time of day, a number of operation hours, switching the display on or off, etc., or the display may activate the compensation mode based on a combination of factors.

When the field calibration is activated, at block 202, the on-board calibration unit 1 will check the ambient lighting level to determine whether or not there is too much washout of the calibration signals, in which case if it is not a suitable light level, meaning if the ambient illuminant is too bright, then it will postpone the calibration sequence, otherwise if the brightness of the ambient illumination is suitable then the calibration sequence proceeds.

When the calibration proceeds, the system takes a measurement of the ambient light that is to be subtracted, at block 204. The on-board calibration unit 1 stores ambient light intensity values for each detector in the memory 13.

At block 206, a sample intensity value is collected for each pixel. Each pixel is provided with a same or a preset data signal. The data signals are not all provided at once, but rather, the data signals can be applied as discussed with reference to FIGS. 11 and 12. The coupling components 10 cause a portion of the light 14 emitted by the pixels 12 to be coupled to the waveguides 6. The waveguides transmit the coupled light 16 to the detectors 8 which measure the intensity of light. The detectors 8 provide the sample intensity values to the on-board calibration unit 1.

At block 208, the on-board calibration unit 1 subtracts the ambient light intensity values from the corresponding sampled pixel intensity values to get corrected sampled intensity values.

At block 210, the on-board calibration unit 1 compares the sampled intensity values (or the corrected sampled intensity values) with the intensity values that were stored at time of manufacture.

At block 212, the on-board calibration unit 1 calculates difference values and, using the difference values, calculates compensation factors for each pixel such that the luminance of each pixel can be restored to the original levels at time of manufacture or to another uniform level.

At block 214, the on-board calibration unit 1 stores the compensation factors in non-volatile memory 13 and at block 216, the compensation factors are applied either to the input signal or to the display itself during operation to compensate for degradation of the pixels 12.

In this way, a display according to embodiments of the present invention can make a correction that compensates for any aging or pixel degradation regardless of the cause.

Although this invention has been described in certain specific embodiments, those skilled in the art will have no difficulty devising variations to the described embodiment, which in no way depart from the scope and spirit of the present invention. Furthermore, to those skilled in the various arts, the invention itself herein will suggest solutions to other tasks and adaptations for other applications. It is the applicant's intention to cover by claims all such uses of the invention and those changes and modifications which could be made to the embodiments of the invention herein chosen for the purpose of disclosure without departing from the spirit and scope of the invention. Thus, the present embodiments of the invention should be considered in all respects as illustrative and not restrictive, the scope of the invention to be indicated by the appended claims and their equivalents rather than the foregoing description.

What is claimed is:

1. A display comprising:
a light emitting display panel;
an optical layer on the display panel comprising:
a waveguide; and
a light coupling component in the waveguide;
a detector optically coupled to the waveguide; and
an on-board calibration unit electrically coupled to the detector and configured to modify an output of the light emitting display panel based on a measurement made by the detector.

2. The display of claim 1,
wherein the light coupling component comprises a plurality of anisotropic scatterers,
wherein the anisotropic scatterers are substantially distributed near the interface of the core and cladding of the waveguides, and
wherein the anisotropic scatterers are roughly aligned along the direction of the waveguides.

3. The display of claim 1,
wherein the light coupling component comprises a plurality of quantum dots.

4. The display of claim 1,
wherein the display panel comprises a plurality of pixels,
wherein the waveguide comprises a plurality of waveguides, and
wherein the pixels are arranged in N rows and M columns, where N and M are natural numbers.

5. The display of claim 4,
wherein the plurality of waveguides comprises N waveguides, and
wherein each of the waveguides corresponds to one of the rows of the pixels.

6. The display of claim 4,
wherein each of the pixels comprises multiple (S) sub-pixels,
wherein the plurality of waveguides comprises M*S waveguides, and
wherein each of the waveguides corresponds to one of the columns of sub-pixels.

7. The display of claim 4,
wherein the plurality of waveguides comprises M/i waveguides (i is a natural number), and wherein each of the waveguides corresponds to i of the columns of the pixels.

8. The display of claim 1,
wherein the waveguide comprises a plurality of fibers.

9. The display of claim 1,
wherein the detector comprises a plurality of detectors,
wherein each of the detectors is coupled to a corresponding one of the waveguides, and
wherein the detectors are located at alternating sides of the display panel.

10. A display comprising:
a display panel;
an optical layer on the display panel;
a detector configured to detect light transmitted by the optical layer; and
an on-board calibration unit electrically coupled to the detector and configured to modify an output of the light emitting display panel based on a measurement made by the detector.

11. The display of claim 10, wherein the optical layer comprises a plurality of anisotropic scatterers.

12. The display of claim 10, wherein the optical layer comprises a plurality of quantum dots.

13. The display of claim 10,
wherein the display panel further comprises a plurality of pixels,
wherein the optical layer comprises a plurality of waveguides,
wherein the detector comprises a plurality of detectors, and
wherein the pixels are arranged in N row and M columns, where N and M are natural numbers.

14. The display of claim 13,
wherein the plurality of waveguides comprises N waveguides, and
wherein each row of pixels corresponds to one of the waveguides and two of the detectors.

15. The display of claim 13,
wherein each of the pixels comprises multiple (S) sub-pixels,
wherein the plurality of waveguides comprises M*S waveguides, and
wherein each of the waveguides corresponds to one column of sub-pixels and two of the detectors.

16. The display of claim 10,
wherein the detector comprises a plurality of detectors,
wherein the optical layer comprises a plurality of waveguides,
wherein each of the detectors is coupled to a corresponding one of the waveguides, and
wherein the detectors are located at alternating sides of the display panel.

17. A method of compensating for degradation of a display panel, the method comprising:
measuring a sample intensity value for each of a plurality of pixels;
comparing the sample intensity value of each of the pixels to a corresponding reference pixel intensity value, to compute a difference value for each of the pixels;
calculating a compensation factor for each of the pixels based on the corresponding difference value; and
storing the compensation factor for each of the pixels.

18. The method of claim 17, further comprising:
adjusting pixel luminance based on the compensation factor.

19. The method of claim 17, further comprising:
storing background intensity values for each of a plurality of detectors; and
subtracting the background intensity values from the sample intensity values for each of the pixels, respectively.

20. The method of claim 17,
wherein the sample intensity values are measured in a number of discrete measurements.
